(19) United States
(12) Patent Application Publication
(10) Pub. No.: US 2022/0377251 A1
(43) Pub. Date: Nov. 24, 2022

(54) Device to Capture High Resolution Images of the Underside of a Freight Car Traveling at Full Speed

(71) Applicants: Jeremy Grata, Jacksonville, FL (US); Edward Buschelman, Jacksonville, FL (US); Julie Lee, Jacksonville, FL (US)

(72) Inventors: Jeremy Grata, Jacksonville, FL (US); Edward Buschelman, Jacksonville, FL (US); Julie Lee, Jacksonville, FL (US)

(21) Appl. No.: 17/326,427

(22) Filed: May 21, 2021

(51) Int. Cl. H04N 5/247; H04N 5/225; H04N 7/18; B61L 23/00

(52) U.S. Cl. CPC H04N 5/247; H04N 5/2256; H04N 7/181; B61L 23/00; H04N 2005/2255; B61L 27/0094

(57) ABSTRACT

A plurality of cameras is secured to railroad ties to take high resolution images of the underside of a train car as it passes over this plurality of cameras. These images are important to insure the structural integrity of the parts of the rail car as well as the connection means—a coupler and pin—between two rail cars. The shutter speed of the cameras is determined by the speed of the train as it passes over the cameras. As the images are taken, the images can be downloaded and sent to a remote location for further analysis.

### FIELD OF THE INVENTION

Trains crisscross the county and are used to transport goods. Trains are comprised of multiple cars and travel on designated routes over tracks. The cars are joined together using couplers; there are many types of couplers in use for this means of transport. It is important for the safe transport of trains that the cars remain coupled. If there is a failure of the coupler and the train cars separate, the train could derail and cause serious personal injury or property damage.

It is important to evaluate the integrity of the coupler system while the train is moving and other structural components of the train car. The current application positions a plurality of cameras on the tracks; these cameras will take high speed images of the underside of the train car and the placement of the cameras will focus on taking high resolution images of the coupler system between the train cars on the train and other structural components of the underside of each individual train car.

While there are many types of couplers in use the specific type of coupler that is referred to in this application and in the industry is known as an F coupler. All the coupler systems use a pin to connect the coupler to the car. In addition to the visual images of the F pin

The coupler keeps the cars interconnected and any failure of the F-pin could lead to derailment and/or serious property and personal injury. This system is an oblique view image acquisition system that captures high resolution images on the undercarriage of freight cars as it travels over the cameras at full speed. In the prior art, in order inspect the F-pin or the knuckles of a train, an individual would manually inspect each pin and each knuckle. This application allows images to be taken while the train travels at full speed and then remotely direct those images to the maintenance location which is typically, at the end of the railroad line or terminal.

This application positions cameras in a predetermined fashion and at predetermined angles to capture the images. The cameras will operate in all environmental conditions and are designed to operate in very adverse environmental conditions including extremes in temperature and extremes in lighting.

### PRIOR ART

The current application employs technology that is in use to determine the speed of a moving train. The speed detection device is synchronized with the shutter speed for the cameras that are used in this application. This application uses multiple cameras to take high resolution images of the underside of a moving rail car.

There is prior art that uses multiple cameras to take images from multiple views and a representative example can be found at Buibas, U.S. Pat. No. 10,282,852. This reference I used to track an individual in a store and multiple cameras are placed in the store to track the individual. While this application also uses multiple cameras, the cameras in this application are designed to take high speed images of the undersigned of a rapidly moving objects i.e. moving train cars.

Another example of the prior art can be found at Schofield, US Patent Publication 2017/0237946 which is a cabin monitoring system. This application tracks the movement of an occupant inside a vehicle. While multiple cameras are used in this instance, this application does not employ a plurality of lights that are activated at certain predetermined times.

Another example in the prior art that monitors the condition of train tracks using sensors can be found at Singh, U.S. Pat. No. 10,518,791. This device is not designed to take images of the underside of a moving train.

While there are other prior art references, none of the references teach the multiple features that are found in this application.

### BRIEF SUMMARY OF THE INVENTION

Trains move rapidly over tracks and a train will ordinarily consists of multiple cars that are connected using couples that are commonly referred to as “knuckles” that interlock with each other. As an added precaution a pin will be used to lock the cars in place. While there are many different types of pins and the use of a particular type of pin will vary depending on the type of train, the purpose of the pin is the same: to make sure that the train cars remain connected. A failure of the pin or the knuckle may result in a derailment that may result in serious personal or property damage.

The pin and other connection means (knuckles) must be periodically inspected. Currently this inspection occurred when the train was stopped and a person would visually inspect all the pin assemblies. While the focus of this device is the inspection of the pin assembly, other parts of the train structure are also viewed, and images taken.

This device uses a series of cameras that are placed on the tracks and will take high resolution images of the underside of the train car as it moves over the tracks.

There are a total of ten cameras, four from the middle looking out from the center of the track and upward at a predetermined angle from the track, four near the edges of the track pointing inward and upward, and two positioned on the outside edge of the interior of the track to capture images of the specific pin that is used on the train. In this application an “F pin” will be discussed.

The F pin is a pin that goes through the coupler, which is at one end of the knuckle. A cotter pin through the F pin and another pin, thought the F pin through the cotter pin are used to secure the F pin in place. It is important to make sure the F pin stays intact, but unfortunately, the configuration of the F pin is such that it is typically hard to visualize during normal operations because of surrounding structures on the underside of the train car.

All the cameras are equipped with LED light that surround the lens; the lights and camera will be activated through software that is linked to a linear speed detection device. The linear speed detection device is used to detect the speed of a moving train in very precise terms; the software determines the shutter speed of the cameras.

There are six LED lights, and they were placed as close to the camera lens to eliminate shadowing. The LEDs however produce a great amount of heat and that was one of the considerations when the placement of the LED was being considered. The cameras are turned on and off using the linear speed sensor and the shutter speed is typically 120 frames per second. Regarding the specific use of the motor car carrier and the hopper car, the F pin is used on those.

There is a plastic window that is made from very durable material over the LEDs to protect them from dust and debris that is inevitable with the operation of a train. Camera windows are protected by a sapphire covering which is specifically used because of its extreme durability.

Two cameras are specifically designed to take images of the F-pin and its surrounding structure and the other cameras are used to take images of other parts of the underside of a moving train car.

These images can then be forwarded to a remote location for analysis and stored for forensic use if needed.

### BRIEF DESCRIPTION OF THE DRAWINGS

FIG. 1 is a perspective view of the camera and LED of the F-pin camera

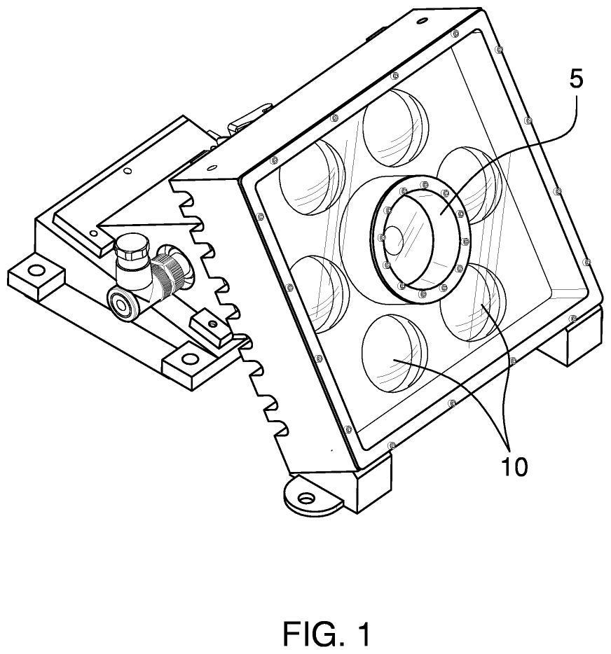

FIG. 2 is a front view of the camera and LED of the F-pin camera

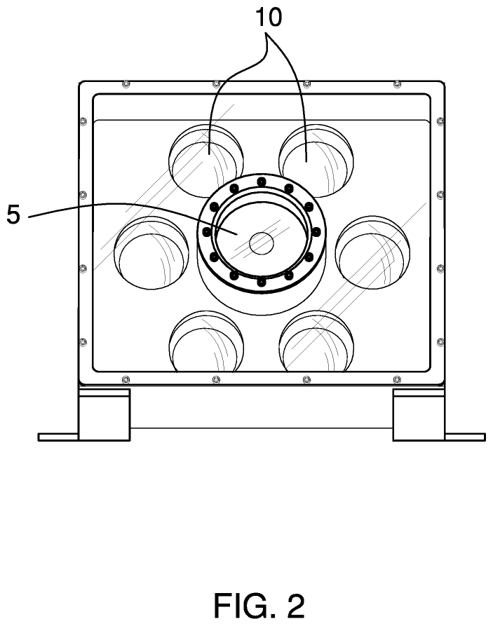

FIG. 3 is a top view of the cameras

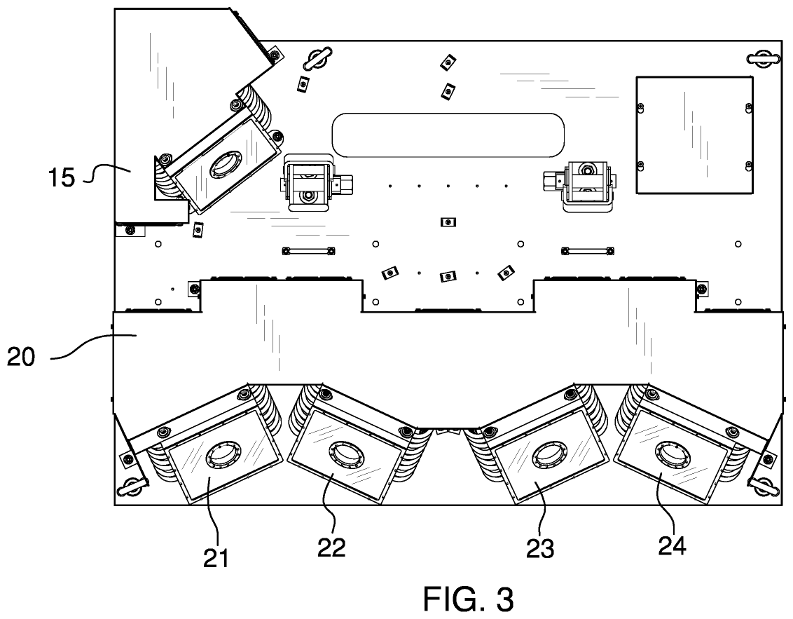

FIG. 4 is an in-use view of the device installed on the railroad track

FIG. 5 is an in-use view of the device on the track with a train car passing over the device

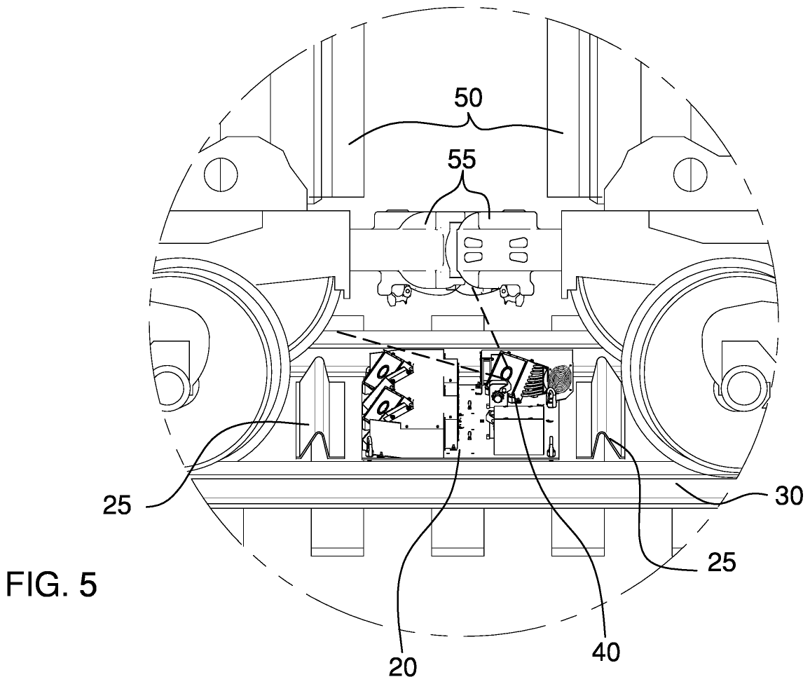

### NUMBERING REFERENCES

5 Camera
10 LED lights
15 F-pin camera
20 Camera Module
21 First Inner Camera
22 First Outer Camera
23 Second Outer Camera
24 Second Inner Camera
25 Shields
30 Track
50 Freight Car
55 Coupler

### DETAILED DESCRIPTION OF THE EMBODIMENTS

It is important at times to take high resolution images of moving freight trains as it passes over sections of tracks. Trains are typically located in remote locations and travel at relatively high speeds. The failure of a train either through the separation of train cars or the train leaving the track or derailing will cause catastrophic damage both to persons or property. A constant challenge is to insure the structural integrity of the train including all connecting means—the couplers—between cars is maintained. It is important to view the underside of the individual train cars to ensure this integrity. Each of the cars is connected together by a coupler; a securing pin is placed to lock the two cars in place during normal operation of the train.

This device uses a series of cameras, which are mounted to the rail ties. These cameras operate at a predetermined shutter speed to take high resolution images of the underside of the individual freight cars. A total of ten cameras will be used with this application. The cameras are positioned in such a way to take very specific images of different parts of the underside of a freight train.

The cameras will be comprised of a pair of F-pin cameras 15. Although the term “F-pin” is discussed in this application the purpose of these cameras is to take high resolution images of the connecting pins and coupler assembly between rail cars; there are many different types of pins and couplers that are used to join train cars. While there are many hoses in use on a train, the failure of a pin and/or the coupler will certainly result in the cars separating from each other and produce a catastrophic result.

The F-pin cameras are place on either side of the device in the interior space between the rails for a train. One of these F-pin cameras 15 will face inward and slightly upward at a predetermined angle to capture the F-pin and coupler mechanism from one angle. A second F-pin camera is placed on the interior of the inside of the opposite track to capture the images from that perspective. In this manner images of the coupler and pin can be obtained regardless of the direction of the train. The F-pin cameras are designed to be placed with an optical axis elevated thirty degrees above the horizontal plane and between a desired range of twenty-five and thirty-five degrees.

In this example, each of the cars is coupled together using a pin mechanism and a coupler. The coupler typically has a knuckle assembly, which latches on to a corresponding knuckle assembly to the train car both in front of and behind each car that comprise the train.

The F-pin and coupler assembly is typically in the center of the car, so the two F-pin cameras are positioned to focus on the area near the center of the car.

In addition, other cameras are used to take images of the underside of the train car but not specifically focusing on the F-pin and coupler. There are many other structural features of the underside of a train car that should be viewed and analyzed. These cameras will consist of two camera modules 20 that will face each other when the device is installed. On each camera module will be placed two inner cameras, 21 and 24 and two outer cameras, 22 and 23.

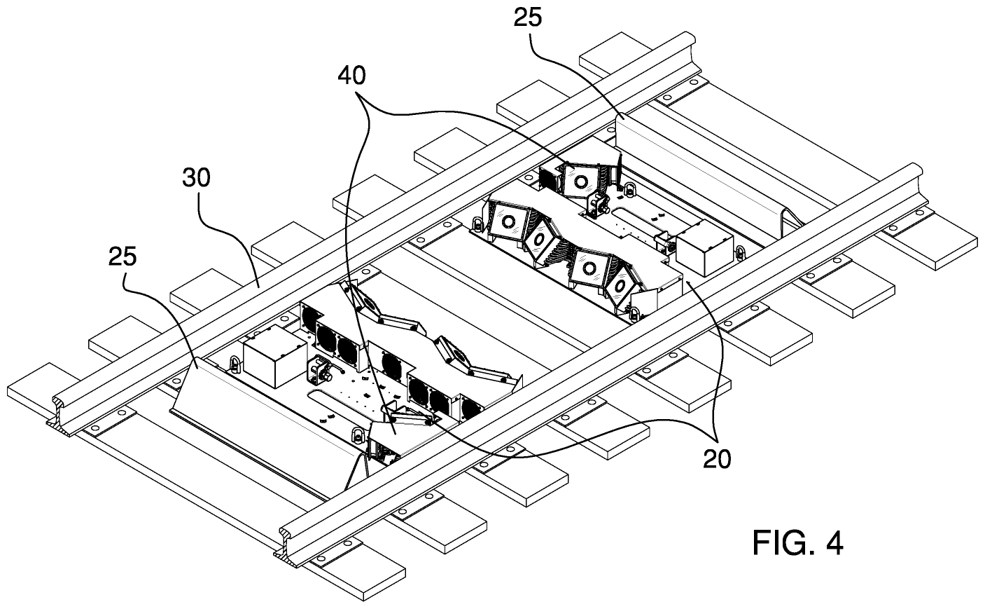

The two inner cameras, 21 and 24 face are placed on either outside edge of the camera module 20 and are positioned to take images inward as the train passes over the device. Similarly, the two outer cameras, 22 and 23, are placed on both sides of the center of the camera module 20 and are positioned to take pictures outward and upward as the train moves over the device. Two separate camera modules 20 are used such as depicted in FIG. 4. The inner cameras and outer frame cameras are designed with an optical axis elevated forty degrees above the horizontal plane and between a range of thirty-five and forty-five degrees.

A pair of shields 25 are inserted as part of the device to reduce as much as possible the effects of dust and debris that is inevitable as the train passes over the device.

Each of the cameras 5 is comprised of a center shutter, that is commonly found in any camera. A plurality of LED lights 10 surrounds the perimeter of the camera lens. A certain predetermined number of LED lights 10 are used to produce sufficient light for the camera to take high resolution images and reduce glare or shadows at the same time. Each of the individual cameras 5 will have a plurality of LED light 10 around the perimeter of the camera lens. Each of the cameras must be expected to operate in all types of lighting conditions. The shutter speed of the individual cameras is regulated by a linear speed detection device that measures the speed of the oncoming train very precisely.

As the train approaches, software for the linear speed detection device will operate the cameras and the lighting to determine the optimal shutter speed that is required based on the speed of the train. After the train has passed over the area the cameras and LED lights are powered down and turn off. A protective cover is placed over the cameras and lights for additional protection from debris as the train passes over the device that is secured to the train tracks.

Software is employed to take the individual camera images and transmit them to a remote location for further analysis.

The device also uses a steel plate to cover the inner and outer cameras in each module; each module is secured to the rail ties between the rails to prevent the bouncing ties from damaging the cameras as a train passes over the ties.

Each of the cameras are designed to operate in adverse lighting conditions and all environmental extremes.

The inventor claims:

1. A device to capture high resolution images on the underside of a freight train traveling at full speed, which is comprised of:
a first F-pin camera;
wherein the first F-pin camera is secured to the interior of a railroad track on the interior of the railroad track;
wherein the first F-pin camera has a shutter;
wherein the shutter of the first F-pin camera is positioned inward toward the center of the track;
wherein the first F-pin camera shutter is positioned in an upward configuration at a predetermined angle along an optical axis;
a second F-pin camera;
wherein the second F-pin camera is secured to the interior of a railroad track on the interior of the railroad track;
wherein the second F-pin camera has a shutter;
wherein the shutter of the second F-pin camera is positioned inward toward the center of the track;
wherein the second F-pin camera shutter is positioned in an upward configuration at a predetermined angle along an optical axis;
wherein the position of the first F-pin camera shutter and the second F-pin camera shutter are facing each other;
a first camera module;
wherein the first camera module is secured to the interior of the railroad tracks;
wherein the first camera module extends from the interior of one railroad track to the interior of the opposite railroad track;
wherein four cameras are secured to the first camera module;
wherein the four cameras are further comprised of two outer cameras and two inner cameras;
wherein the two outer cameras are positioned upward at a predetermined degree above the horizontal plane;
wherein the two outer cameras are positioned to take images of the inward surfaces of the underside of the railroad car;
wherein the two inner cameras are positioned upward at a predetermined angle along an optical axis;
wherein the two inner cameras are positioned to take images of the inward surfaces of the underside of the railroad car;
a second camera module;
wherein the second camera module is secured to the railroad track;
wherein the second camera module extends from the interior of one railroad track to the interior of the opposite railroad track;
wherein four cameras are secured to the second camera module;
wherein the four cameras are further comprised of two outer cameras and two inner cameras;
wherein the cameras on the first camera module face the cameras on the second camera module;
a plurality of LED lights;
wherein the plurality of LED lights are positioned around the perimeter of the lens of the cameras;
wherein the cameras are mounted to the rail tie;
wherein a steel structural plate is placed over the first camera module;
wherein a steel structural plate is placed over the second camera module;
wherein the cameras are affixed to the side of the rail between the railroad tracks.

2. A device to capture high resolution images on the underside of a freight train traveling at full speed as described in claim 1 wherein the cameras operate in extremes in environmental conditions.

3. A device to capture high resolution images on the underside of a freight train traveling at full speed as described in claim 1, wherein the angle of placement along the optical axis for the F-pin cameras is thirty degrees above the horizontal plane.

4. A device to capture high resolution images on the underside of a freight train traveling at full speed as described in claim 3, wherein the angle above the horizontal plane for the F-pin cameras is between twenty-five and thirty-five degrees.

5. A device to capture high resolution images on the underside of a freight train traveling at full speed as described in claim 1, wherein the angle of placement along the optical axis for the inner cameras is forty degrees above the horizontal plane.

6. A device to capture high resolution images on the underside of a freight train traveling at full speed as described in claim 5, wherein the angle of placement along the optical axis for the inner cameras is between thirty-five and forty-five degrees above the horizontal plane.

7. A device to capture high resolution images on the underside of a freight train traveling at full speed as described in claim 1, wherein the angle of placement along the optical axis for the outer cameras is forty degrees above the horizontal plane.

8. A device to capture high resolution images on the underside of a freight train traveling at full speed as described in claim 6, wherein the angle of placement along the optical axis for the outer cameras is between thirty-five and forty-five degrees above the horizontal plane.
